(19) United States
(12) Patent Application Publication
(10) Pub. No.: US 2023/0364628 A1
(43) Pub. Date: Nov. 16, 2023

(54) PORTABLE MISTER ASSEMBLY

(71) Applicant: Maria Gumanit FOTI, Henderson, NV (US)

(72) Inventor: Maria Gumanit FOTI, Henderson, NV (US)

(21) Appl. No.: 18/314,851

(22) Filed: May 10, 2023

Related U.S. Application Data
(60) Provisional application No. 63/340,404, filed on May 10, 2022.

(51) Int. Cl. B05B 9/04; B05B 15/62; F24F 5/00

(52) U.S. Cl. CPC B05B 9/0403; B05B 15/62; F24F 5/0035

(57) ABSTRACT

Portable mist dispenser systems are disclosed. One mist dispenser system includes a mister assembly (8) including at least one mister nozzle (27) configured to form a mist of water droplets. The system further includes a pump assembly (5) including a water pump configured to pump water through the mister nozzle (27) to form the mist of water droplets, a battery configured to power the water pump, and at least one magnet configured to mount the pump assembly (5) to a metal frame (12). In addition, the system includes a water reservoir (2) coupled to the pump assembly (5) to provide the water to form the mist of water droplets. Additionally or alternatively, the pump assembly (5) is coupled to the mister assembly (8) and the reservoir (2) through respective flexible tubes and includes a universal serial bus (USB) charging port configured to charge the battery.

### CROSS REFERENCE TO RELATED APPLICATIONS

This application claims priority to U.S. Provisional Application No. 63/340,404, filed on May 10, 2022, the entire contents of which are incorporated herein by reference.

### TECHNICAL FIELD

The present disclosure relates to mister systems and devices and, in particular, portable mister assembly systems and devices.

### BACKGROUND

Misting systems typically employ a series of specialized mist nozzles placed in a line around the perimeter of an area. Such systems can produce billions of tiny droplets every second. If these droplets are introduced into an outdoor area, they quickly evaporate. Thus, hot and dry climates are optimal conditions for misting systems. Higher temperatures provide the opportunity for maximum temperature reduction. Outdoor misting systems can lower the ambient temperature in an area by converting hot air into cold air to provide cooling comfort in open spaces. The heat of summer can pose a matter of great inconvenience for many, and misting can be utilized to combat and lower the temperature, and add moisture to dry air at the same time. A significant advantage of misting systems that they can cool an outdoor area where air conditioning is not feasible.

Misting systems use the evaporation principle for cooling an assigned area and usually can reduce the temperature by as much as 30 degrees. Misting systems produce tiny water droplets, which raise humidity and cools without getting anything wet. Moreover, misting systems can provide health benefits, as the small water droplets can work together to eliminate tiny particles of dirt, dust, and odor-causing bacteria by attracting and absorbing the particles from the air.

The current state of misting is primarily based on a stationary system that requires a garden hose style water source. Such a stationary misting system is attached to a garden hose or other stationary water source, and the misters are permanently attached to walls. These types of misting systems are not movable or portable. Portable misting systems are also available for use when a water source is not accessible, usually for agricultural usage, but they require large water reservoirs and an electric power source which is either AC power or a large battery, and are not suitable for use in golf carts.

Current portable misting systems designed for golf carts are essentially stationary devices that are not easily removable from the golf cart. These devices require a complex attachment apparatus and a connection to the golf cart battery.

One known portable misting device includes a hand pump spray canister with a mist nozzle attached to the end of an extended spray wand. The spray wand can wrap around the inside of a golf cart and the fluid is dispersed through pressurizing the canister by hand-pumping the sprayer. Other known portable misting devices include electric mister spray bottles that are designed for watering plants and produce a straight line or dispersed spray.

### SUMMARY

A problem with typical misting systems, such as those noted above with respect to agricultural usage, is that they are not sufficiently portable. While agricultural misting systems can be portable, they are not hand-held or lightweight, nor are they practical for carrying around, such as within a golf bag, for example, or placing on a golf cart. Although misting systems for golf carts exist, as noted above, they are effectively stationary devices. They are not hand-held or portable, and are not easily removable from the golf cart, as they are designed to be a permanent fixture to the golf cart. Further, they also require a connection to the golf cart battery. Thus, these types of systems are not suitable for, for example, a weekend golfer seeking to easily install and remove a misting system from a rented golf cart.

Moreover, the hand pump spray device discussed above is inconvenient because it requires hand pumping of the nozzle to generate a mist, and wrapping the misting wand around a golf cart. This device does not use a battery powered spray nozzle, thereby limiting the pressure that can be generated by the device and, as a result, limit the quality of the mist producible by the device. Furthermore, wrapping the misting wand around the golf cart is cumbersome and inconvenient.

In addition, electric mister spray bottles discussed above do not have misting nozzles and provide no means of attaching the device to a metal frame, such as, for example, a frame of a golf cart. In these devices, the water is transmitted in a straight spray and tends to soak the surrounding area rather than provide an evaporating mist. Furthermore, these devices have straight spray nozzles that do not rotate in different directions. They also lack magnetic extension mister nozzles which can be attached to various parts of a golf cart.

In contrast to existing misting devices, embodiments of the present application provide a portable mist dispenser system having parts that can easily be attached to and removed from a metal frame, such as, for example, on a golf cart, an outdoor table, a chair or post in a public park, for example, through the use of magnets. In accordance with exemplary embodiments, various magnetic attachment features can be leveraged to provide a small, light-weight, portable and hand-held mist dispenser system that can be carried to and installed at virtually any desired outdoor space to cool ambient air and, in particular, on different parts of a golf cart.

Further, the mist dispenser system according to one exemplary aspect can include a rechargeable battery, for powering an automatic pump, that can be charged through a universal serial bus (USB) charging port disposed on a pump assembly. Here, the mist dispenser system can be compartmentalized with parts coupled through flexible tubes so that the pump assembly is spaced from both a water reservoir and mister nozzles. This feature enables convenient installment or placement of the pump assembly to be disposed near, for example, a USB port of a golf cart or phone charger outlet at the center of a table, while at the same time permitting mounting of mister nozzles at appropriate parts of the golf cart or table fixture and placement of the water reservoir in a convenient location that does not obstruct use of the cart or movement of people about a table.

On exemplary aspect of the present application is directed to a mist dispenser system. The system comprises a mister assembly including at least one mister nozzle that is configured to form a mist of water droplets. The system also includes a pump assembly, where the pump assembly includes a water pump configured to pump water through the mister nozzle to form the mist of water droplets, a battery configured to power the water pump, and at least one magnet configured to mount the pump assembly to a metal frame. In addition, the system includes a water reservoir coupled to the pump assembly to provide the water to form the mist of water droplets.

According to one exemplary embodiment, the mister assembly includes at least one magnet configured to mount the mister assembly to the metal frame. In one version of this embodiment, the pump assembly is configured to pump the water to the mister assembly through a first flexible tube and to obtain the water from the water reservoir through a second flexible tube. In addition, the pump assembly comprises a USB charging port configured to charge the battery. In another version of the embodiment, the pump assembly is formed as a dispenser handle. Further, according to one exemplary feature, the mister assembly, the pump assembly, the water reservoir, and the first and second flexible tubes are configured to fit within a pouch having an area that is less than one square foot. In accordance with another exemplary feature, the mister assembly includes a hollow coupler comprising a coupling tube configured to receive the water at a first end of the coupling tube from the pump assembly and to output the water at a second end of the coupling tube for receipt by the mister nozzle. Further, according to another exemplary feature, the magnet(s) of the mister assembly is disposed at an external surface of the hollow coupler. In one version of the embodiment, the mister assembly includes an adjustable member on which the mister nozzle is mounted, where the adjustable member is movable to alter a direction in which the mist is formed when the mister assembly is mounted to the metal frame. According to one exemplary feature, the coupling tube is connected to a T-coupling within the hollow coupler and the adjustable member is mounted on the T-coupling outside of the hollow coupler.

Another exemplary aspect of the present application is directed to a mist dispenser system comprising a mister assembly including at least one mister nozzle configured to form a mist of water droplets and a pump assembly coupled to the mister assembly through a first flexible tube, where the pump assembly includes a water pump configured to pump water through the first flexible tube and the mister nozzle to form the mist of water droplets, a battery configured to power the water pump, and a universal serial bus (USB) charging port configured to charge the battery. The system further includes a water reservoir coupled to the pump assembly through a second flexible tube to provide the water to form the mist of water droplets.

In accordance with one exemplary embodiment, the mister assembly includes at least one magnet configured to mount the mister assembly to a metal frame. In one version of this embodiment, the mister assembly includes a hollow coupler comprising a coupling tube configured to receive the water at a first end of the coupling tube from the pump assembly and to output the water at a second end of the coupling tube for receipt by the at least one mister nozzle. According to one exemplary feature the magnet is disposed at an external surface of the hollow coupler. In accordance with another exemplary feature, the mister assembly includes an adjustable member on which the at least one mister nozzle is mounted, where the adjustable member is movable to alter a direction in which the mist is formed when the mister assembly is mounted to the metal frame. In one exemplary configuration, the coupling tube is connected to a T-coupling within the hollow coupler and the adjustable member is mounted on the T- coupling outside of the hollow coupler.

According to another exemplary embodiment, the pump assembly is formed as a dispenser handle.

In accordance with an additional embodiment, the mister assembly, the pump assembly, the water reservoir, and the first and second flexible tubes are configured to fit within a pouch having an area that is less than one square foot.

### BRIEF DESCRIPTION OF THE DRAWINGS

In order to more clearly illustrate the embodiments of the present disclosure, a brief description of the drawings is given below. The following drawings are only illustrative of some of the embodiments of the present disclosure and for a person of ordinary skill in the art, other drawings or embodiments may be obtained from these drawings without inventive effort.

FIG. 1 is a diagram of a mist dispenser system in accordance with an exemplary embodiment;

FIG. 2 is a diagram of a side view of a mist dispenser system installed on a golf cart in accordance with an exemplary embodiment;

FIG. 3 is a diagram of a top view of mister assembly in accordance with an exemplary embodiment;

FIG. 4 is a diagram of a side view of a pump assembly in accordance with an exemplary embodiment;

FIG. 5 is a block diagram of a pump assembly in accordance with an exemplary embodiment;

FIG. 6 is a diagram illustrating storage of a mist dispenser system in accordance with an exemplary embodiment within a golf bag;

FIG. 7 is a diagram of a mist dispenser system in accordance with an alternative exemplary embodiment; and

FIG. 8 is a diagram of a mist dispenser system installed on an outdoor table in accordance with an exemplary embodiment.

### DETAILED DESCRIPTION

The technical solutions of the present disclosure will be clearly and completely described below with reference to the drawings wherein like reference numerals are used to refer to like elements throughout. The embodiments described are only some of the embodiments of the present disclosure, rather than all of the embodiments. All other embodiments that are obtained by a person of ordinary skill in the art on the basis of the embodiments of the present disclosure without inventive effort shall be covered by the protective scope of the present disclosure.

The present principles are directed to a portable evaporative cooling system. In accordance with an exemplary aspect, the system includes features that enable simple and convenient installment. For example, in a preferred embodiment, parts of the system are configured with magnetic attachment features that permit both installation and removal on different parts of a metal frame, of, for example a golf cart, an outdoor, table or the like, to enable an appropriate misting function and convenient control, as well as a small and lightweight configuration to enhance portability and storage.

In accordance with another exemplary aspect, the system can include a battery for powering a pump of the system that is chargeable via a USB port on the pump assembly. Here, the pump assembly can be separated from both mister nozzles and a water reservoirs and placed in a convenient location permitting both charging and control, such as near a USB charging port of a golf cart or a phone charger disposed near the surface of an outdoor table. The USB port and separation features facilitate the incorporation of the rechargeable battery to enable both portability of the entire system as well as the generation of continuously sprayed and higher quality mist due to the pressures applied by a pump powered by such a battery. In addition, the pump assembly separation features also enable mounting of mister nozzles at suitable parts of a golf cart, a table fixture or the like, as well as placement of the water reservoir in an unobstructive location that does not hinder operation of the cart or use of an outdoor table or the like.

Moreover, inclusion of a rechargeable battery and the magnets on the pump assembly and extension nozzles permit not only easy installation, but also customization of the positioning of the misters in virtually any location around a circumference of, for example, a golf cart. The utilization of a battery-operated nozzle allows for a continuous misting spray and higher compression rates which will produce finer droplets of evaporating spray, as indicated above. The user is not required to continually hand pump the nozzle. Further, in accordance with an exemplary embodiment, the system employs a 360-degree rotatable misting coupling and extension nozzles to create fine droplets of evaporating water mist that can cool the air and not just spray water on the occupant. The mister nozzles can be rotated in multiple indirect directions to cool a wider area. In addition, the attachment of a large water source/reservoir provides a continuous water supply.

A preferred embodiment of the present application is directed to a portable multidirectional misting dispenser that includes a rechargeable battery powered hand-held misting handle employed as a pump assembly, a mister assembly and a plastic container that can be easily carried and transported to provide a cooling mist to an individual on demand without the need for an outside water or electric power source. The misting nozzles preferably employ a coupling composed of a hollowed out receptible device, such as a plastic golf ball, for example. The hollowed object has magnets attached to allow for hookup to metal objects, such as, for example, the mental frame of a golf cart. These couplings are attached by a flexible, preferably plastic, hose to a battery-operated dispenser to disperse liquid through the misting nozzles in fine mists. The device includes a water source hookup for extended use during extremely hot days.

Preferably, the system is hand-held and can be employed to cool a golf cart, but the system can be used in any environment that would benefit from portable misting, and can also be set on a table, placed in a basket, inserted in a cupholder, or attached to any metal object. While the cooling system can be used anywhere, the system is especially applicable to cooling a golf cart in dry, hot weather by easily carrying the system in a golf bag and then attaching the system to the golf cart with magnets.

Preferably, the system is a self-contained device that can be carried in a golfer’s bag. As noted above, the nozzle uses a USB rechargeable battery that can be connected to a USB port on the golf cart. Further, magnets are attached to the misting nozzles and pump assembly, embodied within a spray handle, which allow for easy connection to the metal frame of the golf cart. In addition, the extension nozzles can be hooked up to a reservoir or a main water system with slip-on connectors and attached to/detached from the frame of the golf cart with magnets. In accordance with a preferred embodiment, the entire system can be carried in a golf bag for easy transport.

The system can be employed in other settings, such as, for example, for diners at an outside café on hot sunny days, as not all outside cafés have built-in misting systems. The customer or owner of the establishment can place the system on or near a table and create a personal misting system for the patron. This personal misting system can also be attached to a moving object, such as, for example, an autonomous floor cleaner or other autonomously movable device to provide an indirect misting affect throughout an area.

The system may also be used at outside sporting events, either by the athletes or the attending crowd to cool the surrounding air with an evaporating mist. For example, the system, with its stand-alone water supply, battery and extension misting nozzles, can be set up on the sidelines to cool the area and attending fans can carry their own systems and bring them to the event for personal cooling.

Further, while the evaporative cooling system can be provided in the cab area of a golf cart, it can also be mounted on other types of open-air vehicles by attaching the system to produce a misting spray of water. An electric pump system of the pump assembly draws water from a water reservoir and pumps the water through liquid conveying tubes into a mist dispenser which provides the pressurized water through atomizing spray nozzles, as discussed in further detail herein below. The water source could be a container attached to, for example, a golf cart frame or set inside a golf cart, or other vehicle. The system may also include an inline on/off switch to control flow to an additional, secondary mister nozzle.

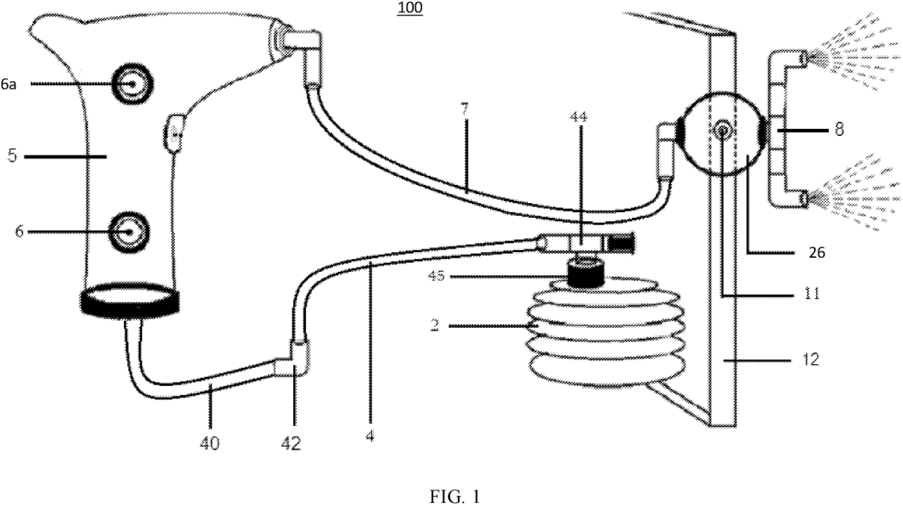

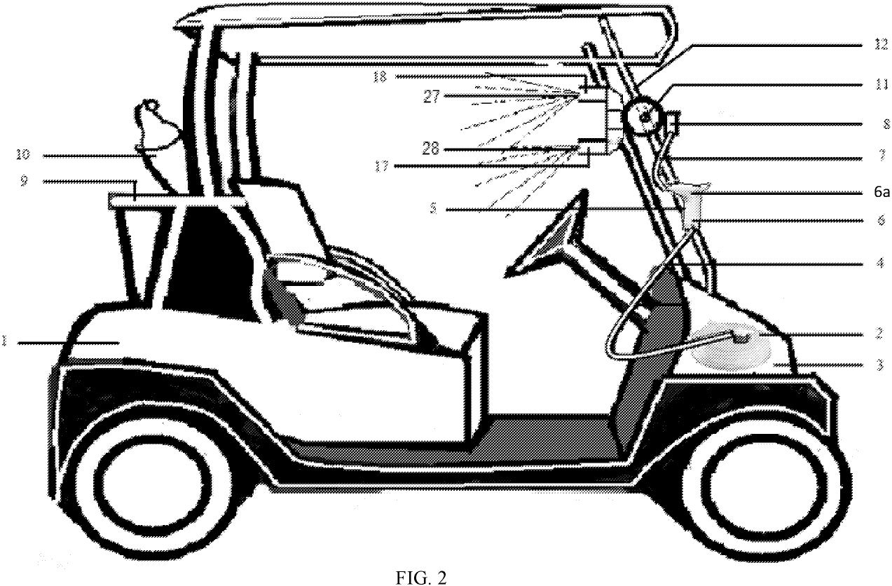

With reference now to FIGS. 1 and 2, a mist dispenser system 100 in accordance with an exemplary embodiment is illustratively depicted. FIG. 1 illustrates components of the system 100, while FIG. 2 illustrates the system 100 attached to a standard golf cart 1. The system 100 includes a water reservoir 2, which can, for example, be implemented as a plastic container, a pump assembly 5, which can be implemented as or formed as a spray handle assembly or dispenser handle as illustrated in FIGS. 1 and 2, a mister assembly 8 and flexible tubes 4 and 7, both of which can for example, be plastic, rubber and/or flexible metallic tubes. The system 100 can be carried to and from the golf course in a golf bag and is easily attached and removed from the golf cart 1 with the attached magnets 6, 6a and 11. This allows, for example, weekend golfers to carry the system to the golf course in their golf bag and attach the device when needed.

As shown in FIG. 2, the water reservoir 2 is a portable water bottle, which can be located on the front shelf 3 as shown or on the back shelf 9 or in the sand bottle assembly 10. The water reservoir 2 is connected to an electric rechargeable handheld pump assembly 5, which in this embodiment is implemented as a spray handle assembly, with a flexible tube 4. The spray handle assembly 5 is connected to the mister assembly 8 through a flexible tube 7, and the mister assembly 8 emits the liquid in a fine mist. The spray handle assembly 5 is attached to the cart frame 12 with magnets 6 and 6a. The mister assembly 8 is attached to the metal cart frame 12 with magnet 11.

The tubes 4 and 7 are flexible to allow for easy assembly to the cart 1. In addition, in accordance with one exemplary aspect, each of the tubes 4 and 7 can be, for example, 3-5 feet in length, respectively. However, it should be understood that other lengths can be used. The flexible tubes may be bent, twisted, or otherwise configured to accommodate various types and styles of golf cart. While the golf cart 1 of FIG. 2 is illustrated having one mister assembly 8, it should be understood that the system 100 can be expanded to include multiple mister assemblies 8 that can be attached to various positions of the cart 1, or of another metal frame. In accordance with one exemplary feature, the tube 7 may be run along the top or along the side of the cart 1 and the mister assembly 8 can be attached to the cart frame 12 without any mechanism other than a magnet 11 and in such a way that the tube 7 and the mister assembly 8 do not interfere with the operational or aesthetic aspects of the cart 1.

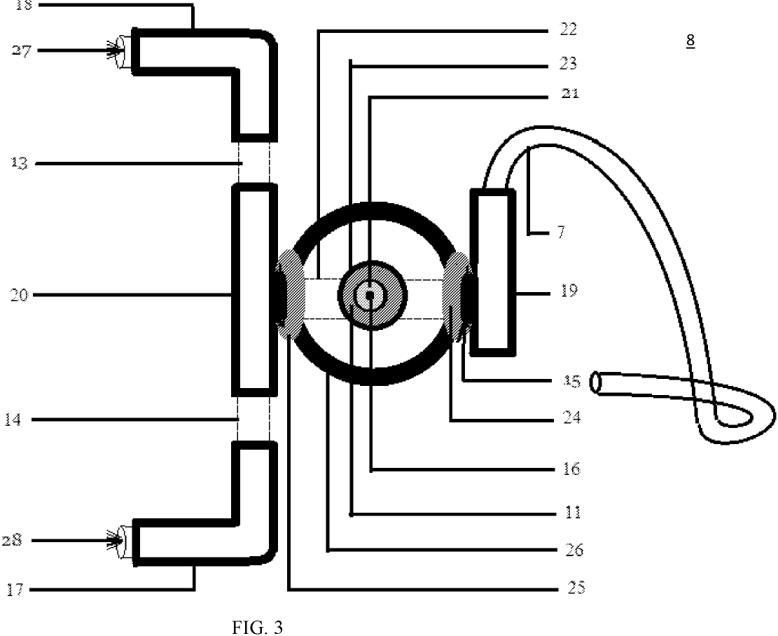

The liquid water is pumped from the reservoir 2 through tubes 4 via the spray handle assembly 5 to the mister assembly 8 for a continuous supply of the liquid to the misting nozzles 27 and 28 to effectuate the evaporative cooling. In particular, the water reservoir 2 is coupled to the pump assembly 5 through the flexible tube 4 to provide the water to form a mist of water droplets. As indicated in FIG. 3, the ‘L’ type or L-couplings 17 and 18 are adjustable members that can alter the direction in which the liquid mist is released to account for wind, humidity, and one’s personal preference. Here, each of the adjustable members 17 and 18 on which the mister nozzles 28 and 27 are respectively mounted are movable to alter a direction in which the mist is formed when the mister assembly 8 is mounted to the metal frame 12.

Additional mister assemblies 8 can be added in sequence with additional plastic tubes 7. If additional mister assemblies 8 are attached, an inline on/off control (not shown) switch is conveniently located between the mister assemblies 8 to allow a second golf cart occupant to turn the cooling system on and off as desired.

The portable device provides a continuous spray of mist and eliminates the need for costly and complex equipment. The present principles may be utilized in numerous applications such as, for example, in an open cabin vehicle (e.g., golf carts, industrial or agricultural equipment) or in areas where AC power or water source is not available, such as, playgrounds and parks, ballfields, driving ranges, or tennis courts. The portable nature of the device allows it to be used in outdoor dining areas where traditional misting apparatus are impractical due to a lack of water source or electricity.

Referring again to FIG. 3, which continuing reference to FIGS. 1-2, FIG. 3 illustrates a mister assembly 8 in accordance with an exemplary embodiment. The assembly 8 is attached to the water source/reservoir 2 through the flexible tube 7 connected to an ‘L’ Type or L-coupling 19 which connects to the spray handle assembly 5. The mister assembly 8 in accordance with one exemplary embodiment includes a short coupling tube 22, which can be plastic, rubber or a flexible metal tube, that is approximately ½” in length and is inserted into a coupling (preferably an L-type coupling or L-coupling) 19 which is inserted into a rubber grommet 24. Although the coupling tube 22 here is approximately ½” in length, the length of the coupling tube 22 can be different in other embodiments. As indicated in FIGS. 1-3, a hollow coupler 26 includes the coupling tube 22, and the coupling tube 22 is configured to receive water at a first end of the coupling tube from the pump assembly via tube 7 and to output the water at a second end of the coupling tube for receipt by the mister nozzle 27 and 28. A hole 15 about ¼” in diameter in this example (holes with other diameters can be formed in alternative embodiments) is drilled through the hollow object or coupler 26, which can be, for example, a plastic golf ball, with a diameter large enough to insert the coupling 19. The rubber grommet 24 is pushed onto coupling 19 which is then inserted into the hole 15 of the hollow coupler 26 and the rubber grommet 24 is pushed tight against the hollow coupler 26. The coupling tube 22, which is preferably plastic, is inserted into the coupling 19 inside the hollow coupler 26. A rubber grommet 25 is inserted onto a “T” type or T-coupling 20. The T-coupling 20 is pushed onto the tube 22 on the opposite side of the hollow coupler 26 and then the grommet 25 is pushed tight into the hole 15 of the hollow coupler 26. As illustrated, for example, in FIG. 3, the coupling tube 22 is connected to the T-coupling 20 within the hollow coupler 26 and the adjustable members 17 and 18 are mounted on the T-coupling 20 outside of the hollow coupler 26.

A pin hole 16 is drilled into the side of the hollow object 26. A magnet 11 is attached to the hollow coupler 26 with a screw or rivet 21 and then a rubber gromet 23 is placed around the magnet 11. Further, tubes 13 and 14, which can be, for example, plastic, are inserted into each end of the T-coupling 20 and then L-coupling 18 is inserted onto tube 13 and L-coupling 17 is inserted onto tube 14. A mister nozzle 27 is inserted into the L-coupling 18 and a mister nozzle 28 is inserted into the L-coupling 17.

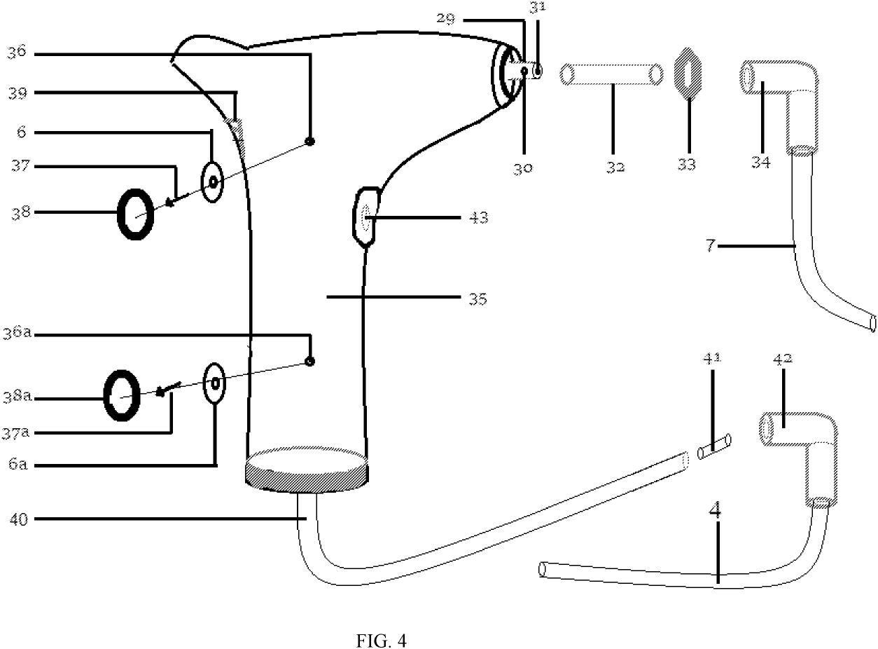

Referring now to FIG. 4, with continuing reference to FIGS. 1-3, FIG. 4 illustrates components of a pump assembly 5 in accordance with an exemplary embodiment, implemented here as an electric-powered nozzle, also referred to as a spray handle assembly or dispenser handle. The spray handle assembly 5 comprises a nozzle handle 35 which has an on/off switch 43, USB rechargeable outlet or charging port 39, a flexible hose 40, which can, for example be plastic, rubber or a flexible metal, extending from the bottom of the handle 35 where liquid is pumped from a bottle through an exit spout 29. It should be noted that the hose 40 is optional, and the hose 4, in some embodiments, can be directedly connected to the nozzle or spray handle 35. Pin holes 30 are, typically, formed on the sides of the spout 29. The exit spout 29, in accordance with an exemplary embodiment, is modified by drilling a pin hole 31 into the center of the exit spout 29. A flexible tube 32, which can be, for example, plastic, rubber or a flexible metal, is inserted over the exit spout 29 and firmly attached with a securing fastener such as, for example, a hex nut 33. A coupling, preferably an “L” Type or L-coupling 34, is inserted over the tube 32. The tube 7 is inserted into this misting coupling 34 to pump water to the mister assembly 8.

The handle 35 is further modified by drilling pin holes 36 and 36a into various locations. Magnets 6 and 6a are attached to the handle 35 by inserting rivets 37 and 37a or screws through the magnets 6 and 6a and pin holes 36 and 36a, respectively. Rubber grommets 38 and 38a are then inserted over the magnet 6 and 6a. These magnets 6 and 6a are used to attach the handle 35 to a metal frame or surface, such as, for example a metal frame 12 of the golf cart 1.

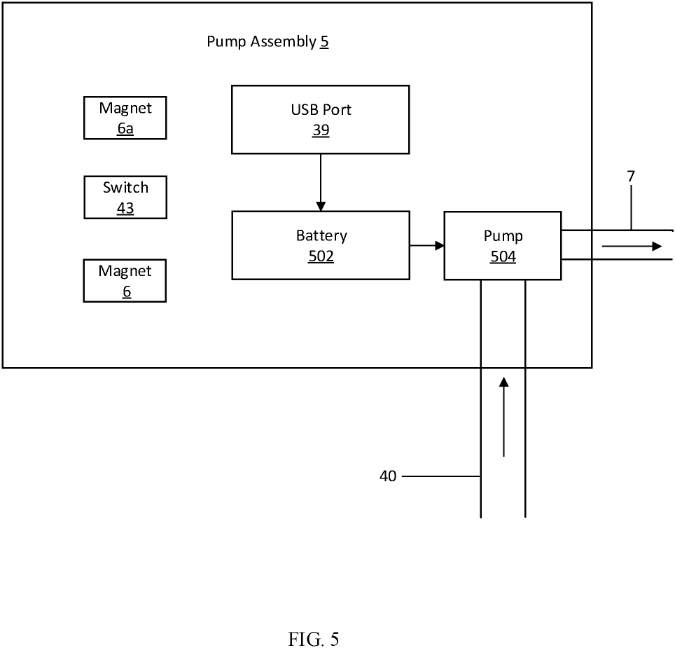

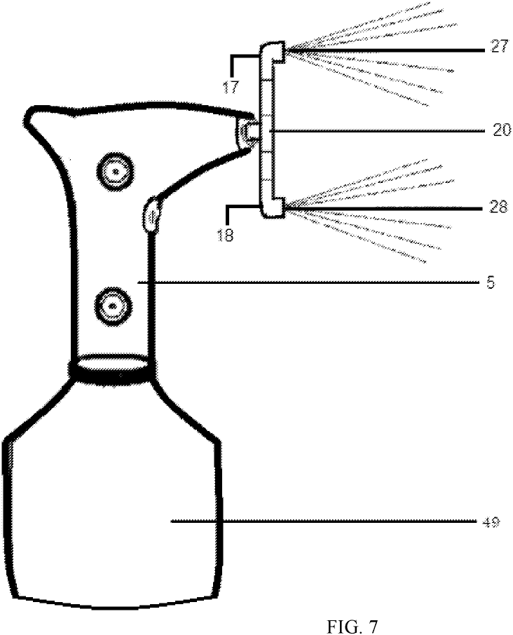

Referring again to FIG. 1, which illustrates the mist dispenser system 100 in accordance with an exemplary embodiment comprising the mister assembly 8 and the pump assembly 5, implemented as a spray nozzle assembly, attached to a detachable water container or reservoir 2. The mister assembly 5 is attached here, in this embodiment, to a golf cart metal bar 12 with the magnet 11. The mister assembly 8 has water pumped into it through a plastic tube 7 that is attached to the pump assembly 5, implemented here as a spray handle assembly 5. For example, as illustrated in FIG. 5, the pump assembly 5 includes magnets 6a and 6, a rechargeable battery 502, a USB port 39 configured to charge the rechargeable battery 502, which in turn powers the water pump 504 of the pump assembly 5. The water pump 504 is configured to pump water through the tube 7 and subsequently through mister nozzles 27 and 28 to form a mist of water droplets. Here, the water is received by the pump 504 from the reservoir 2 through the tube 40, which, as noted above is optional. In other embodiments, water can be transmitted into the pump 504 from the reservoir 2 directly from the tube 4. As illustrated in FIG. 1, the spray handle assembly 5 has two magnets 6 and 6a which can be attached to a metal bar of, for example, the metal frame 12 of a golf cart 1. Extending from the bottom of the spray handle assembly 5 is the flexible hose or tube 40 that connects to an L-coupling 42 which connects to the extension tube 4, which can be, for example, plastic, rubber or a flexible metal. This tube 4 connects to a coupling 44 that is attached to cap 45 in a water container or reservoir 2. A hole is drilled into the cap 45 to insert the coupling 44. Preferably a “T” type or T-coupling 44 is employed, where a second spray handle assembly 5 can be attached on the side of the coupling 44 opposite to the side of the coupling 44 on which the tube 4 is attached. The water reservoir 2 in this exemplary embodiment is a collapsible plastic container 2 that can be collapsed into a flat disk. This feature allows for the entire system 100, including the mister assembly 8, the pump assembly 5, the water reservoir 2, and each of the tubes, to be carried in a small bag or pouch 46. An alternative water container or reservoir can be a standard water bottle container 49 shown in FIG. 7. In the embodiment of FIG. 7, the water reservoir is directly coupled to the pump assembly 5 without a tube or a hose and the mister assembly 8 is also directly coupled to the pump assembly 5 without a tube or a hose. In the embodiment of FIG. 7, the pump assembly is implemented as a spray handle assembly 5 attached to a standard bottle container 49. The spray handle assembly 5 is attached directly to a water bottle 49 and directly to coupling 20. The hollow coupler 25 is eliminated from the system in this embodiment. The couplings 17 and 18 are attached to coupling 20 and house mister nozzles 27 & 28, which can spin in 360 degrees for direct or indirect misting. This alternative assembly shows the portability and versatility of the system. With this assembly the system is a self-contained unit that can be easily carried and can be set on a table for outside dining where a permanent mister system is not available. Further, with the use of a standard water bottle, the system can be easily carried and be placed on any flat surface, such as, for example, a table or step. Each of these water containers, whether a standard water bottle container or a container illustrated in FIG. 1, can fit into small bag, such as a golf bag, for easy transport.

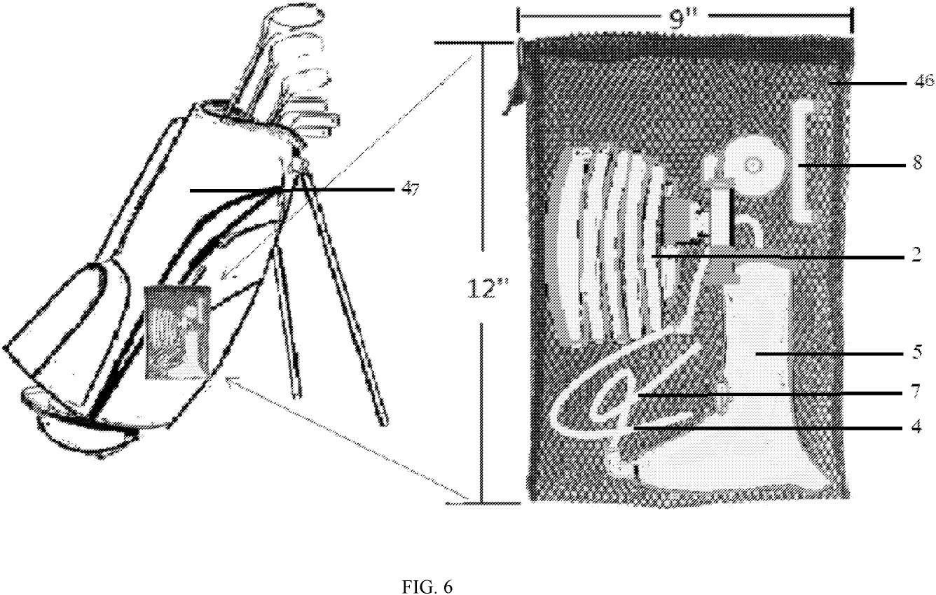

For example, as illustrated in FIG. 6, the mist dispenser system 100 can be stored in a small bag or pouch 46 having an area that is less than one square foot. In this particular embodiment, the pouch has dimensions of 9″ by 12″ as indicated in FIG. 6. The system is lightweight, compact and easily portable within a golf bag 47. The spray handle assembly 5, mister assembly 8, tubes 4 and 7, and reservoir or container 2 in particular can be easily caried in the small bag or pouch 46 and stored and carried in a golf bag 47.

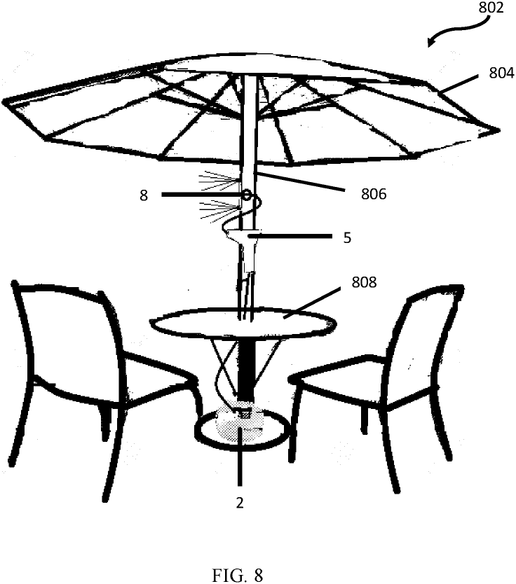

Referring now to FIG. 8, as noted above, the mist dispenser system 100 can be installed on a variety of different objects. For example, in FIG. 8, the mister assembly 8 and the pump assembly 5 are both mounted on a metal frame 806 of an umbrella 804 of an outdoor table 802. Further, the reservoir 2 can be conveniently stored beneath the table top 808 so that it does not obstruct movement of people or chairs about the table. The reservoir 2 is connected to the tube 4 which connects to the pump assembly 5, implemented here as a spray handle assembly. The tube 7 connects the pump assembly 5 to the mister assembly 8, which is attached to the umbrella pole/frame 806 with a magnet 11. The pump assembly 5 is attached to the umbrella pole frame 806 with magnets 6 and 6a. The system could be used at any outdoor restaurants where a permanent mister system is not available.

The above-mentioned embodiments of the present disclosure are only examples for describing the present disclosure more clearly, rather than limiting an implementation mode of the present disclosure. For those of ordinary skill in the art, other variations or changes in different forms can be made on the basis of the above description. For example, in accordance with alternative embodiments, the charging port 39 need not be a USB charging port and could in some embodiments can be other types of charging ports, such as, for example, ports for a 5.5 mm, 3.5 mm or 4.7 mm AC adapter connector. In accordance with alternative embodiments, the battery 502 need not be rechargeable, but could be removeable and replaced at the end of its life. Moreover, the pump assembly 5 and/or the mister assembly 8 need not employ magnets for mounting to a metal frame or other surfaces. In some embodiments, the pump assembly 5 and/or the mister assembly 8 can include other attachment elements, such as, for example, clips, adhesives, etc. It is impossible to list all implementation systems here. The obvious variations or changes derived from the technical solutions of the present disclosure still fall within the scope of protection of the present disclosure.

What is claimed is:

1. A mist dispenser system comprising:
a mister assembly including at least one mister nozzle configured to form a mist of water droplets;
a pump assembly including a water pump configured to pump water through the mister nozzle to form the mist of water droplets, a battery configured to power the water pump, and at least one first magnet configured to mount the pump assembly to a metal frame; and
a water reservoir coupled to the pump assembly to provide the water to form the mist of water droplets.

2. The mist dispenser system of claim 1, wherein the mister assembly includes at least one second magnet configured to mount the mister assembly to the metal frame.

3. The mist dispenser system of claim 2, wherein the pump assembly is configured to pump the water to the mister assembly through a first flexible tube and to obtain the water from the water reservoir through a second flexible tube.

4. The mist dispenser system of claim 3, wherein the pump assembly comprises a universal serial bus (USB) charging port configured to charge the battery.

5. The mist dispenser system of claim 4, wherein the pump assembly is formed as a dispenser handle.

6. The mist dispenser system of claim 3, wherein the mister assembly, the pump assembly, the water reservoir, and the first and second flexible tubes are configured to fit within a pouch having an area that is less than one square foot.

7. The mist dispenser system of claim 2, wherein the mister assembly includes a hollow coupler comprising a coupling tube configured to receive the water at a first end of the coupling tube from the pump assembly and to output the water at a second end of the coupling tube for receipt by the at least one mister nozzle.

8. The mist dispenser system of claim 7, wherein the at least one second magnet is disposed at an external surface of the hollow coupler.

9. The mist dispenser system of claim 7, wherein the mister assembly includes an adjustable member on which the at least one mister nozzle is mounted, wherein the adjustable member is movable to alter a direction in which the mist is formed when the mister assembly is mounted to the metal frame.

10. The mist dispenser system of claim 9, wherein the coupling tube is connected to a T-coupling within the hollow coupler and the adjustable member is mounted on the T-coupling outside of the hollow coupler.

11. A mist dispenser system comprising:
a mister assembly including at least one mister nozzle configured to form a mist of water droplets;
a pump assembly coupled to the mister assembly through a first flexible tube, wherein the pump assembly includes a water pump configured to pump water through the first flexible tube and the mister nozzle to form the mist of water droplets, a battery configured to power the water pump, and a universal serial bus (USB) charging port configured to charge the battery; and
a water reservoir coupled to the pump assembly through a second flexible tube to provide the water to form the mist of water droplets.

12. The mist dispenser system of claim 11, wherein the mister assembly includes at least one magnet configured to mount the mister assembly to a metal frame.

13. The mist dispenser system of claim 12, wherein the mister assembly includes a hollow coupler comprising a coupling tube configured to receive the water at a first end of the coupling tube from the pump assembly and to output the water at a second end of the coupling tube for receipt by the at least one mister nozzle.

14. The mist dispenser system of claim 13, wherein the at least one magnet is disposed at an external surface of the hollow coupler.

15. The mist dispenser system of claim 13, wherein the mister assembly includes an adjustable member on which the at least one mister nozzle is mounted, wherein the adjustable member is movable to alter a direction in which the mist is formed when the mister assembly is mounted to the metal frame.

16. The mist dispenser system of claim 15, wherein the coupling tube is connected to a T-coupling within the hollow coupler and the adjustable member is mounted on the T- coupling outside of the hollow coupler.

17. The mist dispenser system of claim 11, wherein the pump assembly is formed as dispenser handle.

18. The mist dispenser system of claim 11, wherein the mister assembly, the pump assembly, the water reservoir, and the first and second flexible tubes are configured to fit within a pouch having an area that is less than one square foot.
